(19) United States
(12) Patent Application Publication
(10) Pub. No.: US 2022/0183236 A1
(43) Pub. Date: Jun. 16, 2022

(54) METHOD FOR PLANTING PLANTS HAVING STOLONS, AND WEED-PROOF SHEET

(71) Applicant: GREENPRODUCE CO., LTD., Oyama-shi, Tochigi (JP)

(72) Inventor: Masataka OHDE, Oyama-shi (JP)

(21) Appl. No.: 16/972,995

(22) PCT Filed: Jun. 30, 2020
(86) PCT No.: PCT/JP2020/025706

§ 371 Date: Dec. 7, 2020

(51) Int. Cl. A01G 13/02

(52) U.S. Cl. CPC A01G 13/0268

(57) ABSTRACT

Propagation of weeds is prevented in planting plants having stolons. The present invention provides a method for planting plants having stolons, the method including: a step of covering a part of a greening-target soil 10 with a first weed-proof sheet 20 having a rooting property; a step of planting seedlings 30 of the plants in a soil that is not covered with the first weed-proof sheet 20; and a step of covering the seedlings 30 and the soil having the seedlings 30 planted therein with a second weed-proof sheet 50 so that only one or more stolons 40 extending from the seedlings 30 are exposed on the first weed-proof sheet 20.

### TECHNICAL FIELD

The present invention relates to a method for planting plants having stolons, and to a weed-proof sheet suitable for planting plants having stolons.

### BACKGROUND ART

Heretofore, a weed-proof sheet has been used in planting, which means that plants are artificially planted and grown. The weed-proof sheet is laid on the soil to prevent growth of unintended plants, so-called weeds. For example, Patent Literature 1 below discloses a planting method using an instrument called a “weed-proof cap”. The instrument includes a cylindrical tube portion and a collar portion that projects outward from the tube portion. According to this method, since a weed-proof sheet is interposed between the soil and the collar portion of the instrument, a gap that allows light to invade between the instrument and the weed-proof sheet is less likely to occur after the instrument is placed. Hence, according to this method, it is possible to suppress the growth of weeds. However, this method has had a problem that weeds germinate and propagate from around seedlings since the soil around the seedlings is exposed in the instrument and light invades the exposed soil.

### CITATION LIST

### Patent Literature

Patent Literature 1: JP 2009-017873 A

### SUMMARY OF INVENTION

### Technical Problem

An object to be achieved by the present invention is to prevent the growth of weeds in the planting of plants having stolons.

### Solution to Problem

In order to achieve the above object, the present invention provides a method for planting plants having stolons, the method including: a step of covering a part of a greening-target soil with a first weed-proof sheet having a rooting property; a step of planting seedlings of the plants in a soil that is not covered with the first weed-proof sheet; and a step of covering, with a second weed-proof sheet, the seedlings and the soil that is not covered with the first weed-proof sheet so that only one or more stolons extending from the seedlings are exposed on the first weed-proof sheet. Moreover, the present invention provides a weed-proof sheet including: a first covering portion that has a rooting property and covers a soil, the first covering portion having hole portions into which seedlings of plants having stolons are inserted; and a second covering portion that covers the hole portions so that only one or more stolons extending from the seedlings are exposed on the first covering portion.

### Advantageous Effects of Invention

In accordance with the method according to the present invention, a part of the greening-target soil is covered with the first weed-proof sheet, and the soil that is not covered with the first weed-proof sheet (that is, the soil is the rest of the greening-target soil) and the seedlings planted in that soil are covered with the second weed-proof sheet. Accordingly, all of the greening-target soil including the soil around the seedlings can be covered with the first and second weed-proof sheets. Hence, weeds can be effectively prevented from germinating and propagating. On the other hand, since the first weed-proof sheet has the rooting property, the plants are able to propagate so as to fully cover the first weed-proof sheet based on the stolons exposed on the first weed-proof sheets. Moreover, in accordance with the weed-proof sheet according to the present invention, since it is possible to cover all of the greening-target soil including the soil around the seedlings with the first and second covering portions, and accordingly, weeds can be effectively prevented from germinating and propagating. On the other hand, since the first covering portion has the rooting property, the plants can propagate so as to fully cover the first covering portion based on the stolons exposed on the first covering portion.

### BRIEF DESCRIPTION OF DRAWINGS

FIG. 1 is a schematic plan view for explaining methods according to first and second embodiments, illustrating a greening-target soil.

FIG. 2 is a schematic plan view for explaining the method according to the first embodiment, illustrating a state in which a part of the greening-target soil is covered with a first weed-proof sheet.

FIG. 3 is a schematic plan view for explaining the method according to the first embodiment, illustrating a state in which seedlings are planted.

FIG. 4 is a schematic plan view for explaining the method according to the first embodiment, illustrating a state in which the rest of the greening-target soil is covered with a second weed-proof sheet.

FIG. 5 is a schematic plan view for explaining the method according to the second embodiment, illustrating a state in which a part of the greening-target soil is covered with the first weed-proof sheet.

FIG. 6 is a schematic plan view for explaining the method according to the second embodiment, illustrating a state in which seedlings are planted.

FIG. 7 is a schematic plan view for explaining the method according to the second embodiment, illustrating a state in which the rest of the greening-target soil is covered with the second weed-proof sheet.

FIG. 8 is a plan view illustrating a weed-proof sheet according to a third embodiment.

FIG. 9 is a plan view illustrating a first covering portion of the weed-proof sheet according to the third embodiment.

FIG. 10 is a plan view for explaining an example of using the weed-proof sheet according to the third embodiment, illustrating a state in which seedlings are planted.

FIG. 11 is a plan view for explaining an example of using the weed-proof sheet according to the third embodiment, illustrating a state in which hole portions of the first covering portion are covered with a second covering portion.

### DESCRIPTION OF EMBODIMENTS

A specific description will be given below of embodiments of the present invention with reference to the drawings; however, the technical scope of the present invention is not limited to the contents of the following description.

### First Embodiment

A first embodiment is an embodiment of a method according to the present invention.

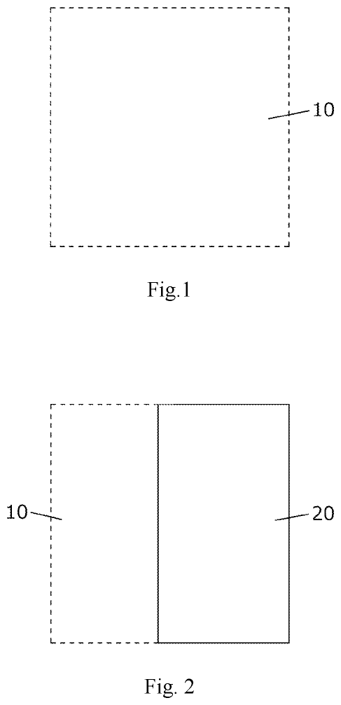

In the first embodiment, first, as illustrated in FIGS. 1 and 2, a part of a greening-target soil 10 is covered with a first weed-proof sheet 20. The first weed-proof sheet 20 is a sheet having a light-shielding property capable of suppressing photosynthesis of weeds. The first weed-proof sheet 20 has a rooting property in addition to the light-shielding property. The rooting property means an ability to pass roots, which extend from the nodes of stolons, from the front surface of the sheet to the back surface of the sheet.

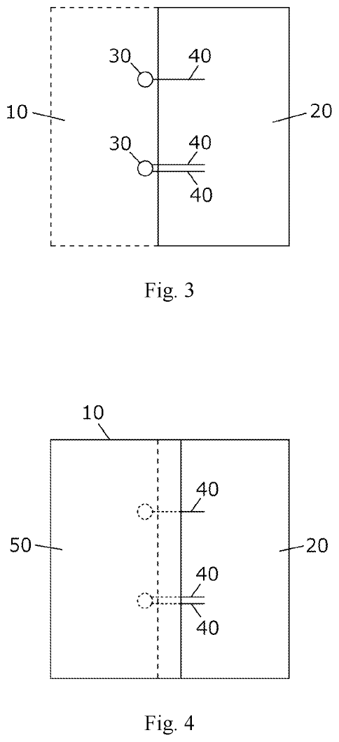

Next, as illustrated in FIG. 3, seedlings 30 of plants having stolons are planted in a soil that is not covered with the first weed-proof sheet 20 (that is, the soil is the rest of the greening-target soil 10). In the first embodiment, the soil that is not covered with the first weed-proof sheet 20 is a soil outside the first weed-proof sheet 20.

Next, as illustrated in FIG. 4, the seedlings 30 and the soil in which the seedlings 30 are planted are covered with a second weed-proof sheet 50 so that only one or more stolons 40 extending from the seedlings 30 are exposed on the first weed-proof sheet 20. Like the first weed-proof sheet 20, the second weed-proof sheet 50 is a sheet having a light-shielding property capable of suppressing photosynthesis of weeds. The second weed-proof sheet 50 may be a sheet of the same type as the first weed-proof sheet 20, or may be a sheet of a different type from the first weed-proof sheet 20. The second weed-proof sheet 50 preferably has a rooting property so that the stolons 40 can grow even on the second weed-proof sheet 50.

In accordance with a method according to the first embodiment, a part of the greening-target soil 10 is covered with the first weed-proof sheet 20, and the soil that is not covered with the first weed-proof sheet 20 (that is, the soil is the rest of the greening-target soil 10) and the seedlings 30 planted in that soil are covered with the second weed-proof sheet 50. Accordingly, all of the greening-target soil 10 including the soil around the seedlings 30 can be covered with the first and second weed-proof sheets 20 and 50. Hence, weeds can be effectively prevented from germinating and propagating. On the other hand, since the first weed-proof sheet 20 has the rooting property, the plants are able to propagate so as to fully cover the first weed-proof sheet 20 based on the stolons 40 exposed on the first weed-proof sheet 20.

An experiment was carried out by the method according to the first embodiment. In this experiment, seedlings of an improved variety (variety registration No. 26198) of Lippia nodiflora (trade name of the seedlings: “Kurapia (registered trademark) K7”, available from Green Produce Co., Ltd.) were used as the seedlings of the plants having stolons. The number of seedlings was two. Further, as the first and second weed-proof sheets, sheets which are made of polyester non-woven fabric, have a light-shielding rate of 98%, and have a rooting property (trade name of the sheets: “Kurapia Multi-Sheet”, available from Green Produce Co., Ltd.) were used. Width of each sheet was 1 m, and length thereof was 1.1 m. Area of the greening-target soil was 2 m² (length 1 m×width 2 m), and this soil was covered with the first and second weed-proof sheets in accordance with the method according to the first embodiment. The first weed-proof sheet and the second weed-proof sheet were laid with an overlap of 10 cm in the length direction. Seventy days after planting the seedlings in accordance with the method according to the first embodiment, all of the first and second weed-proof sheets were fully covered with grown plants. On the other hand, no weeds were found even 142 days after planting the seedlings.

### Second Embodiment

A second embodiment is another embodiment of the method according to the present invention.

The second embodiment is different from the first embodiment in that the soil that is not covered with the first weed-proof sheet 20 is a soil exposed from hole portions 60 formed in the first weed-proof sheet 20.

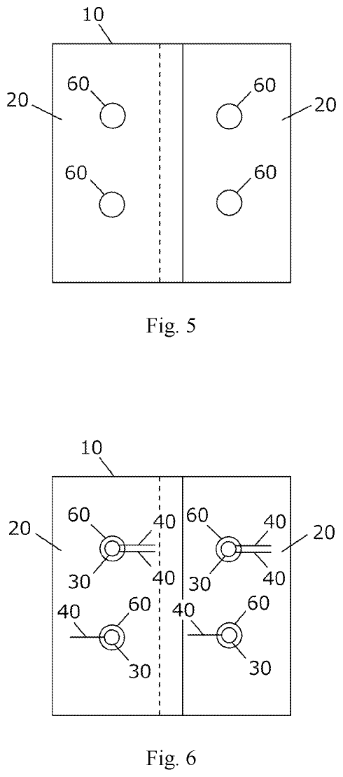

In the second embodiment, first, as illustrated in FIGS. 1 and 5, a part of the greening-target soil 10 is covered with a first weed-proof sheet 20 having the hole portions 60. The first weed-proof sheet 20 has a light-shielding property and a rooting property. In the second embodiment, a plurality of the first weed-proof sheets 20 are used, and the soil that is not covered with the first weed-proof sheet 20 (that is, the soil is the rest of the greening-target soil 10) is the soil exposed from the hole portions 60.

Next, as illustrated in FIG. 6, the seedlings 30 of the plants having stolons are planted in the soil exposed from the hole portions 60.

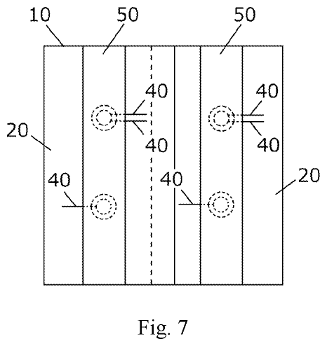

Next, as illustrated in FIG. 7, the seedlings 30 and the soil in which the seedlings 30 are planted are covered with second weed-proof sheets 50 so that only one or more stolons 40 extending from the seedlings 30 are exposed on the first weed-proof sheets 20. Like the first weed-proof sheets 20, the second weed-proof sheets 50 are sheets having a light-shielding property capable of suppressing photosynthesis of weeds. The second weed-proof sheets 50 may be sheets of the same type as the first weed-proof sheets 20, or may be sheets of a different type from the first weed-proof sheets 20. The second weed-proof sheets 50 preferably have a rooting property so that the stolons 40 can grow even on the second weed-proof sheets 50.

In accordance with a method according to the second embodiment, as in the method according to the first embodiment, a part of the greening-target soil 10 is covered with the first weed-proof sheets 20, and the soil that is not covered with the first weed-proof sheets 20 (that is, the soil is the rest of the greening-target soil 10) and the seedlings 30 planted in that soil are covered with the second weed-proof sheets 50. Accordingly, all of the greening-target soil 10 including the soil around the seedlings 30 can be covered with the first and second weed-proof sheets 20 and 50. Hence, weeds can be effectively prevented from germinating and propagating. On the other hand, since the first weed-proof sheet 20 has the rooting property, the plants are able to propagate so as to fully cover the first weed-proof sheets 20 based on the stolons 40 exposed on the first weed-proof sheets 20.

### Third Embodiment

A third embodiment is an embodiment of a weed-proof sheet according to the present invention.

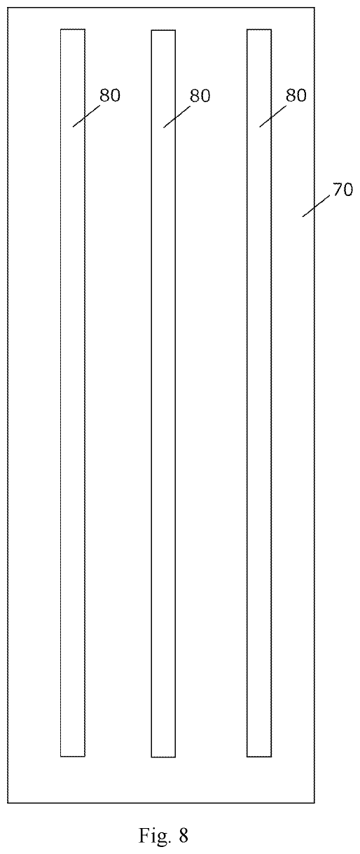

As illustrated in FIG. 8, a weed-proof sheet according to the third embodiment is configured to have a first covering portion 70 and second covering portions 80.

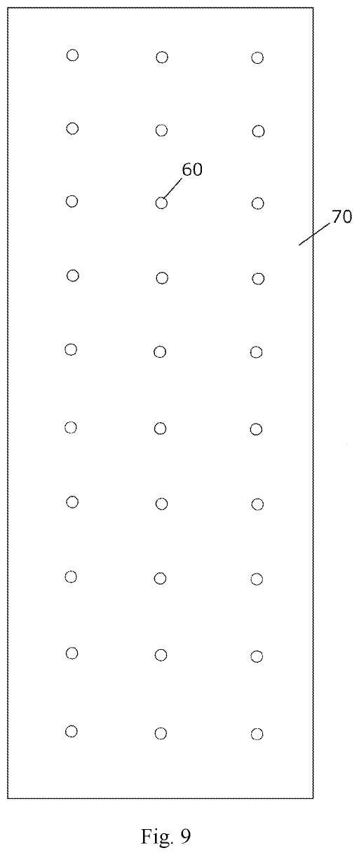

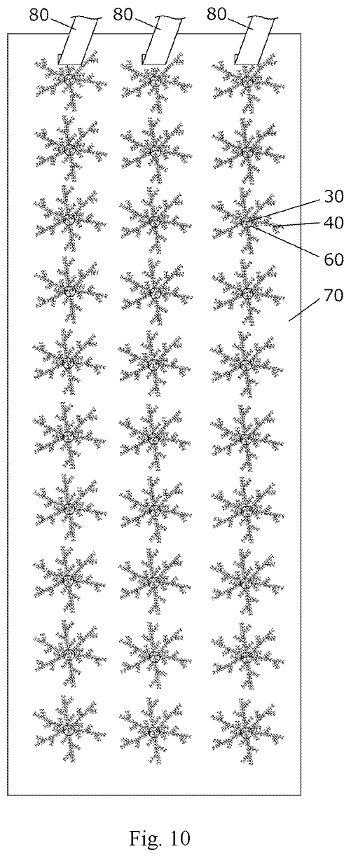

As illustrated in FIG. 9, the first covering portion 70 is a sheet-like member, and has a light-shielding property capable of suppressing photosynthesis of weeds and has a rooting property that allows roots extending from the nodes of the stolons to pass from the front surface of the first covering portion 70 to the back surface of the first covering portion 70. Moreover, the first covering portion 70 has hole portions 60 into which seedlings 30 of the plants having stolons can be inserted.

The second covering portions 80 are sheet-like members capable of covering the hole portions 60 formed in the first covering portion 70, and like the first covering portion 70, has a light-shielding property capable of suppressing photosynthesis of weeds. The second covering portions 80 preferably have a rooting property so that the stolons can grow even on the second covering portions 80. In the third embodiment, one end of each of the second covering portions 80 is attached to the first covering portion 70, but as accessories of the first covering portion 70, the second covering portions 80 may be detachable from the first covering portion 70.

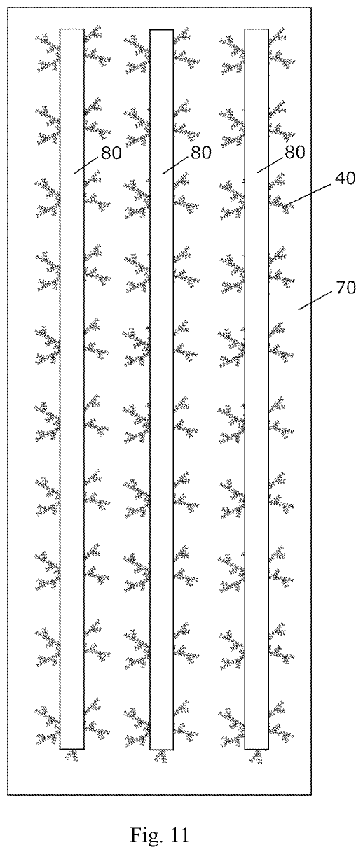

The weed-proof sheet according to the third embodiment is used as follows. That is, first, the first covering portion 70 is laid on the greening-target soil. Next, as illustrated in FIG. 10, the seedlings 30 of the plants having stolons are planted in the soil exposed from the hole portions 60. Next, as illustrated in FIG. 11, the seedling 30 and the hole portions 60 are covered so that only one or more stolons 40 extending from the seedlings 30 are exposed on the first covering portion 70.

In accordance with the weed-proof sheet according to the third embodiment, since it is possible to cover all of the greening-target soil including the soil around the seedlings 30 with the first and second covering portions 70 and 80, and accordingly, weeds can be effectively prevented from germinating and propagating. On the other hand, since the first covering portion 70 has a rooting property, the plants can propagate so as to fully cover the first covering portion 70 based on the stolons 40 exposed on the first covering portion 70.

### REFERENCE SIGNS LIST

10 Greening-target soil
20 First weed-proof sheet
30 Seedling of plant having stolon
40 Stolon
50 Second weed-proof sheet
60 Hole portion
70 First covering portion
80 Second covering portion

1. A method for planting plants having stolons, the method comprising:
a step of covering a part of a greening-target soil with a first weed-proof sheet having a rooting property;
a step of planting seedlings of the plants in a soil that is not covered with the first weed-proof sheet; and
a step of covering the seedlings and the soil having the seedlings planted therein with a second weed-proof sheet so that only one or more stolons extending from the seedlings are exposed on the first weed-proof sheet.

2. The method according to claim 1, wherein the soil that is not covered with the first weed-proof sheet is a soil outside the first weed-proof sheet and/or a soil exposed from hole portions formed in the first weed-proof sheet.

3. The method according to claim 1, wherein the second weed-proof sheet has a rooting property.

4. A weed-proof sheet comprising:
a first covering portion that has a rooting property and covers a soil, the first covering portion having hole portions into which seedlings of plants having stolons are inserted; and
a second covering portion that covers the hole portions so that only one or more stolons extending from the seedlings are exposed on the first covering portion.

5. The weed-proof sheet according to claim 4, wherein the second covering portion is detachable from the first covering portion.

6. The weed-proof sheet according to claim 4, wherein the second covering portion has a rooting property.
